(19) United States
(12) Patent Application Publication
(10) Pub. No.: US 2004/0244466 A1
(43) Pub. Date: Dec. 9, 2004

(54) Ammonia gas sensor and its manufacturing method

(76) Inventor: Chi-Yen Shen, Kaohsiung City (TW)

Correspondence Address: TROXELL LAW OFFICE PLLC, SUITE 1404, 5205 LEESBURG PIKE, FALLS CHURCH, VA, 22041, US

(21) Appl. No.: 10/455,319

(22) Filed: Jun. 6, 2003

(51) Int. Cl. G01N 29/02

(52) U.S. Cl. 73/24.01

(57) ABSTRACT

The invention provides ammonia gas sensor and its manufacturing method. Said ammonia gas sensor comprises a piezoelectric substrate, a surface acoustic wave sensor, and a L-glutamic acid hydrochloride coating; said surface acoustic wave sensor and said L-glutamic acid hydrochloride coating are on the said piezoelectric substrate.

### FIELD OF INVENTION

The invention is related to an ammonia gas sensor and its manufacturing method, in particular related to a acoustic ammonia gas sensor with a L-glutamic acid hydrochloride coating and its manufacturing method.

### BACKGROUND OF INVENTION

The application of sensors has a long history, which evolved from original magnet sensing with a simple compass in China to today's complex and precise optical sensing. However, in the application field of sensors, the evolvement of biochemical sensors is the most important and complete due to the fact that there are too many lethal factors in our living environment, such as harmful pollutants in air, dangerous gases from plants, and viruses or other pathogenic matters endangering human health. In medical science, environmental science, and biochemistry, precise and accurate biochemical sensors still have a vast developing space and huge market potential.

A chemical interface is often coated on sensors to react with the items to be detected. Common coating materials include metal oxides, metals, and polymers. Those coatings have good sensitivity and selectivity to different gases; however, metallic coatings have some limitations in measuring gases due to their smaller dynamic sensing range to gases. Polymer coatings are more suitable for gas sensors due to their higher sensitivity and lower limitation in sensing gases and room temperature operation.

Ammonia gas is a toxic one, which is dangerous both in industrial and bio-chemical and medical applications; ammonia gas is erosive and irritating and may corrode away pipelines in factories, endangering personnel safety and product quality; in addition, the dissolvability of ammonia gas is extremely high and therefore may contaminate skin, mucosa, and conjunctiva, causing stimulation and inflammation; ammonia gas may destroy cilia in pneogaster and mucosa epithelial tissue, resulting in pathogen intrusion and decreased resistance. Furthermore, doctors may detect the existence of some diseases with ammonia gas, for example, the expiration of some patients with hepatic diseases and kidney diseases may contain a minute quantity of ammonia gas.

We have known that a 9 MHz AT-quartz bulk acoustic wave (BAW) sensor with a L-glutamic acid hydrochloride coating may be used to detect ammonia gas. However, the sensitivity of the BAW ammonia gas sensor is only 74 Hz/ppm, which is only effective to 10 ppm or above concentration of ammonia gas. Furthermore, in its perturbation mechanism, only mass loading effect is taken into account, excluding other effects such as elastic effect and acoustoelectric effect. Thus the sensing characteristics of L-glutamic acid hydrochloride are not fully and accurately analyzed with it. In addition, the BAW device only measures in a static state, without any control to environment effects. Another surface acoustic wave (SAW) sensor, which utilizes a Langmuir-Blodgett (LB) polypyrrole coating and is disclosed by Penza, can only detect 20 ppm or above concentration of ammonia gas (M. Penza, E. Milella, V. I. Anisimkin. IEEE Trans. Ultrason., Ferroelect., Freq. Contr., 45, pp. 1125-1131, 1998), and the response degradation rate of LB polypyrrole is 0.025 ppm (M. Penza, E. Milella, V. I. Anisimkin. Sensors and Actuators B, 47, pp. 218-224, 1998). Therefore there is a vast developing space for acoustic wave sensors for ammonia gas.

### OVERVIEW OF INVENTION

The purpose of the invention is to provide an ammonia gas sensor with a L-glutamic acid hydrochloride coating. The device overcomes shortcomings in existing BAW ammonia gas sensors and is featured with high sensitivity, high reversibility, high stability, compactness, low cost, and extensive dynamic range, and is suitable for working in various environments.

The ammonia gas sensor described in the present invention comprises a piezoelectric substrate, a surface acoustic wave sensor, and a L-glutamic acid hydrochloride coating; said surface acoustic wave sensor and said L-glutamic acid hydrochloride coating are on said piezoelectric substrate. Said surface acoustic wave sensor comprises a surface acoustic wave device and a shear-horizontal surface acoustic wave device (SH-SAW); when said surface acoustic wave sensor is applied, it may further comprises a delay line, and one-port resonator, a two-port resonator, and a reflective delay line; said devices comprise interdigital transducers (IDTs) and gratings.

Another purpose of the present invention is to provide a method for manufacturing said ammonia gas sensor; said method comprises: provide a substrate, form a surface acoustic wave sensor on the substrate, and deposit L-glutamic acid hydrochloride solution on the substrate to form a L-glutamic acid hydrochloride coating. Thus an ammonia gas sensor is obtained through above procedures. The ammonia gas sensor in present invention is an acoustic wave-sensor and is featured with compactness, high sensitivity, and high stability. Moreover, the method described in present invention is ideal for mass production because that the surface acoustic wave sensor is formed with photolithography technology and lift-off technology. In addition, the L-glutamic acid hydrochloride coating used in present invention helps to improve the sensitivity to ammonia gas greatly.

Other purposes, characteristics, and benefits of present invention is further disclosed and clarified with the following embodiments and attached drawings.

### BRIEF INSTRUCTION OF THE DRAWINGS

FIG. 1A-1D are schematic diagrams of basic surface acoustic wave devices, wherein FIG. 1A shows a delay line, FIG. 1B shows a one-port resonator, FIG. 1C shows a two-port resonator, and FIG. 1D shows a reflective delay line.

FIG. 2 is a schematic diagram of the ammonia gas sensor described in present invention.

FIG. 3 is a schematic diagram of the ammonia gas sensor in present invention, wherein the ammonia gas sensor detects with a dual delay line system.

FIG. 4 shows the response of the ammonia gas sensor in the present invention to 0.09% ammonia gas concentration.

FIG. 5 shows the frequency shift of the ammonia gas sensor in the present invention to different ammonia gas concentration.

FIG. 6 shows the response of the ammonia gas sensor in the present invention to 0.90 ppm ammonia gas concentration.

FIG. 7 shows the response curve of the ammonia gas sensor in the present invention to a specific ammonia gas concentration.

FIG. 8 shows the response of the ammonia gas sensor in present invention to 1% carbon monoxide.

FIG. 9 shows the result of stability test to the ammonia gas sensor in present invention.

### DESCRIPTION OF THE SYMBOLS

1˜Piezoelectric substrate

2˜SAW sensor

3˜L-glutamic acid hydrochloride coating

4˜Delay line system used in detection

5˜Reference delay line system

6˜Electronic oscillation circuit

7˜Oscillation signal mixer

8˜Frequency counter

### DETAILED DESCRIPTION OF THE INVENTION

1.Evolvement of Acoustic Wave Sensors

The ammonia gas sensor in present invention is a surface acoustic wave-sensor. In 1965, White and Voltmer invented interdigital transducers (IDTs) on the basis of a piezoelectric substrate to produce surface acoustic wave, which is also known as “Rayleigh Wave” [R. M. White and F. W. Voltmer, Appl. Phys. Lett., 17, 314, 1965.].In 1979, Wohltjen and Dessy published the first article disclosing a surface acoustic wave sensor, which may operate at a higher frequency than BAW devices and therefore has a higher sensitivity [H. Wohltjen and R. Dessy, Anal. Chem., 51, 1458, 1979; H. Wohltjen and R. Dessy, Anal. Chem., 51, 1465, 1979]. In 1979, Nakahata and Higaki put forward a diamond multilayer structure (ZnO/diamond/SiO2), the phase velocity of which is up to 10,500 m/s [H. Nakahata, K. Higaki, S. Fujii, and A. Hachigo, IEEE Ultrasonics. Symp. Proc., 361, 1995]. The structure reduces the difficulty in production of high frequency surface acoustic wave devices [Guo Peijing, Manufacturing and Measurement of Piezoelectric Film System and Surface Acoustic Wave Device, Year 89th, Republic of China].

2.Fundamental Principle of Acoustic Wave Sensors

2.1 Basic Theory of Acoustic Waves

2.1.1 Types of Acoustic Waves

Surface acoustic wave is a kind of elastic wave (So-called Rayleigh Wave) created on an infinite isotropic elastic substrate through the excitation of interdigital transducers; the elastic wave mainly concentrates on the surface of the substrate and the energy mainly concentrates within one wavelength (λ) depth of the substrate surface.

The particles move along an elliptic path on the surface of the substrate. When the phase velocity of the acoustic wave is lower than that of the bulk acoustic wave, there is no scattering loss on the surface of the substrate because that there is no phase matching between the surface acoustic wave and the bulk acoustic wave [B. A. Auld, Acoustic Fields and Waves in Solids, vol. 2, Wiley, N.Y., 1973.].

In addition, if the substrate is made of an anisotropic material, there will be more complicated wave patterns, such as shear-horizontal (SH) wave. Though different kinds of waves have unique characteristics, usually there is only one kind of them is suitable under certain conditions for a specific characteristic (e.g., polarization, attenuation, scattering, and coupling to other kinds of waves) [Ulrich Wolff, Franz Ludwing Dickert, Gerhard K. Fischerauer, Wolfgang Greibl, and Clemes C. W. Ruppel, IEEE Sensors Journal, 1, 1, 2001].

2.1.2Excitation of Surface Acoustic Wave

In study of surface acoustic wave technologies, the most important is the piezoelectric effect of piezoelectric substrates. Piezoelectricity is a characteristic of conversion between mechanical energy and electric energy. In 1880, Jaucques and Pierre Curie found that when mechanical press was applied to tourmaline, charges occurred on the surface with the distortion of tourmaline. The polarization created with mechanical distortion was called the piezoelectric effect. Besides tourmaline, piezoelectricity also exists in quartz and rochelle salt [Ikedatakuro, Fundamentals of Piezoelectric Materials Science, translated by Chen Shichun, Fuhan Express]. In addition, the primary structure of piezoelectric materials is non-centrosymmetry of crystal structure, i.e., the center of positive charges is not at the same position as that of negative charges, and thus there is no neutralization among positive and negative charges. In stead, an electric dipole exists.

A key to excitation of surface acoustic wave is the design of IDTs. IDTs are mainly used to excite and receive surface acoustic waves [R. M. White and F. W. Voltmer, Appl. Phys. Lett., 17, 314, 1965]. In a general way, the basic IDT design is to arrange metal electrode pairs in parallel orderly on a piezoelectric substrate and then apply a RF voltage on crossed electrodes to produce an electric field, which will cause mechanical distortion and create surface elastic wave emitted from ends of the IDT due to piezoelectricity; the surface acoustic wave will be converted to voltage output on another IDT owning to the coupling between positive piezoelectric effect and converse piezoelectric effect.

Owing to the discontinuity of mechanical conditions, structure and electric field between electrodes, IDTs will reflect some energy. So IDTs may also be used as acoustic wave reflectors.

With the development of photolithography technology and lift-off technology, IDTs may be manufactured precisely on piezoelectric substrates. Up to now, the distance between electrodes may be as small as 0.8 μm, and the acoustic velocity may be 3,000 m/s to 4,000 m/s, and the maximal operating frequency is about 2.5 GHz [Ulrich Wolff, Franz Ludwing Dickert, Gerhard K. Fischerauer, Wolfgang Greibl, and Clemes C. W. Ruppel, IEEE Sensors Journal, 1, 1, 2001].

2.2 Surface Acoustic Wave Sensor

Surface acoustic wave devices may operate at a higher frequency than BAW sensor. That is to say, it may produce greater frequency variation, which indicates higher sensitivity [D. S. Ballantine, R. M. White, S. J. Martin, A. J. Ricco, E. T. Zellers, G. C. Frye, and H. Wohltjen, Acoustic Wave Sensors, Academic Press, London, 1997]. The acoustic wave device often employ a dual-device architecture, i.e., a surface acoustic wave device without sensing coating serves as the reference device, and the result from the reference device is compared to that from a surface acoustic wave device with a sensing coating, in order to minimize any interference effect from temperature or other environmental factors. In manufacturing of surface acoustic wave sensors, some troubles that don't exist in manufacturing of traditional sealed signal transfer devices occur. For instance, the welding process is crucial. Any irrelevant pressure on the surface acoustic wave device or gas remained in the surface acoustic wave device due to the viscosity of welding material will result in inaccuracy in detection. In addition, in a corrosive environment, a passivation layer may be formed on aluminum electrodes to prevent corrosion, or the electrodes may be made of inactive metallic materials, such as gold or platinum. Furthermore, to reduce water cross-sensitivity, the surface of hydrophilic acoustic wave substrates shall be hydrophobized.

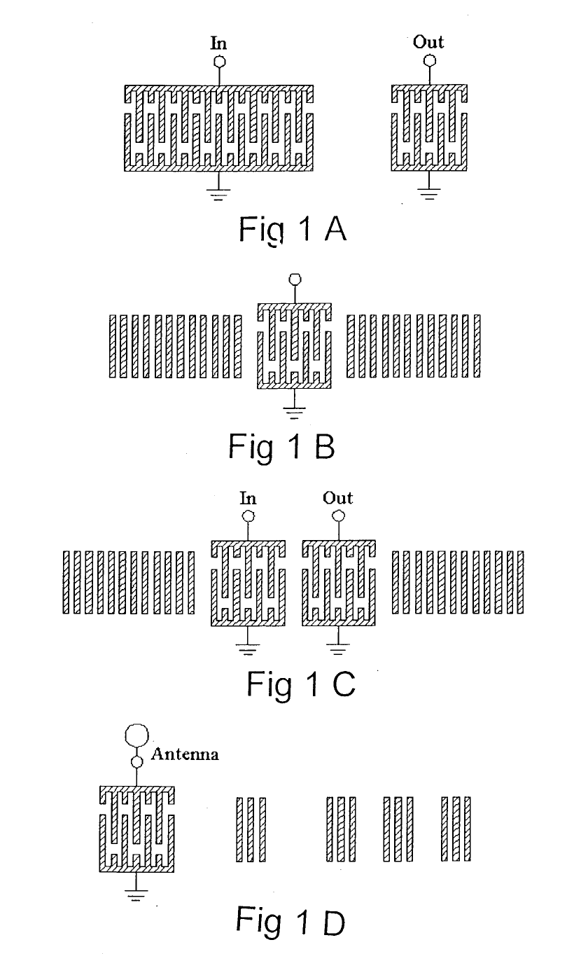

In the field of surface acoustic wave sensors, common devices are delay line ones and resonator ones. In the delay line, the time delay is mainly determined by the distance between the centers of IDTs on the substrate, as shown in FIG. 1A. A resonator comprises one or more IDTs enclosed by gratings, thus the acoustic energy may be constrained in the resonator to minimize energy loss, as shown in FIG. 1B and FIG. 1C. FIG. 1D shows a reflective delay line.

2.3Acoustic Wave Sensing Mechanism

First, the sensing mechanism has to take into consideration of the physical phenomena between the acoustic wave and the object to be measured. Though different acoustic wave devices have unique response mechanisms, several major physical responses are the same. There are 3 response mechanisms between the acoustic wave device and the gas:

(1) Mass Loading (ML) Effect:

Mass loading on the surface of an acoustic wave-sensor will result in deviation of oscillation frequency of the acoustic wave-sensor. Variation of mass loading will only result in perturbation of wave velocity. Mass loading effect exists in every acoustic mode. The main cause for variation of mass loading effect is mass variation resulted from the reaction between the analyte and the coating film during the analyte adsorption (or absorption) process.

(2) Acoustoelectric effect (AE):

Acoustoelectric effect is a phenomenon occurred with the movement of electric charges in the electric field created due to the piezoelectric transduction characteristic of piezoelectric substrate when the acoustic wave propagates along the surface of the substrate and passes a conductive thin coating [A. J. Ricco, S. J. Martin, and T. E. Zipperian, Sen. Actuators B, 319, 1985.]. The effect will result in attenuation of acoustic wave energy or decrease of acoustic wave velocity.

(3) Elastic Effects:

When the energy dissipation from the film can't be omitted or the film is a viscoelastic one, complicated elastic effects will occur, and those elastic effects will alter the energy and velocity of wave. In addition, the alteration of film characteristics (e.g., the size of the film changes when it adsorbs gas) will exaggerate the elastic effects [S. J. Martin, G. C. Frye, and S. D. Senturia, Anal. Chem., 66, 2201, 1994.]. For instance, for a humidity-sensor with a polymer sensing coating, the impacts from mass loading effect and elastic effect vary under different relative humidities [N. M. Tashtoush, J. D. N. Cheeke, and N. Eddy, Sen. Actuators B, 49, 218, 1998.]. In a higher humidity environment, elastic effect is more significant than mass loading effect.

In conclusion, the perturbation resulted from above 3 acoustic wave sensing effects (mass loading effect, acoustoelectric effect, and elastic effect) will cause the phase velocity of acoustic wave to change [A. J. Ricco and S. J. Martin, Thin Solid Films, 206, 94, 1991.], as reflected in the following formula:

$$\begin{matrix}Δυ / {υ}_{o} = - {c}_{m} {f}_{0} {Δρ}_{s} + {c}_{e} {f}_{o} h Δ ⌊ ( 4 μ / {υ}_{o}^{2} ) ( λ + μ ) / ( λ + 2 μ ) ⌋ - \\ ( {K}^{2} / 2 ) Δ [ {σ}_{s}^{2} / ( {σ}_{s}^{2} + {υ}_{o}^{2} {C}_{s}^{2} ) ]\end{matrix} \qquad ( 1 )$$

Wherein Cₘ and Cₑ are sensitivity coefficient and elastic sensitivity coefficient, respectively, ρₛ is the density of the sensing coating, μ and λ are shear modulus and bulk modulus of the sensing coating, respectively, K² is the piezoelectric coupling coefficient of the substrate, σₛ is the sheet conductivity of the sensing coating, and Cₛ is the static capacitance value per unit length of the substrate. Wherein the first item at the right side of the equal mark is mass loading, the second item is elastic effect, and the third item is acoustoelectric effect. From formula (1) we can see that the phase velocity of surface acoustic wave will alter with the variation of mass loading, elastic parameter, and conductivity.

2.4 Efficiency Criteria

In the application of sensors, some factors affecting the performance shall be considered, such as sensitivity, selectivity, reversibility, response time, dynamic range, stability, reliability, and environment effect (e.g., temperature), etc. Starting from some factors, we can select an appropriate substrate or acoustic mode; in addition, how to select the coating or how to operate the sensor under the optimal state is also important. In above factors, selectivity and reversibility are the ones discussed mostly because they are unique for biochemical sensors [D. S. Ballantine, Jr., R. M. White, S. J. Martin, E. T. Zellers, and H. Wohltjen, ISBN 0-12-077460-7 (alk. paper)].

2.4.1 Selectivity

Selectivity refers to the capability that a specific sensor discriminates the response to the analyte and interferences. Selectivity largely depends on the coating material. If a simple polymer, organic or inorganic thin film is used, it is impossible to detect a single analyte. Selectivity requires the sensing coating is highly sensitive to the detected analyte but insensitive to other interferences. For instance, a FPOL thin film coating has very high response to butanone but little response to isooctane. That means a FPOL film has good selectivity to butanone; but the case of PIB thin film coating is quite the opposite, i.e., PIB has good selectivity to isooctane. The sensitivity and selectivity of a sensing coating has intimate relation with the chemical properties of the coating. Therefore, we can select a film matching to the chemical properties of the target analyte to enhance the selectivity of the acoustic wave device.

Several cases shall be avoided at selecting the analyte. For example, high humidity will bring severe perturbation to the detection because that moisture is everywhere in the environment [E. T. Zellers and M. Han, Anal. Chem., 68, 2409, 1996.]; in addition, to avoid the sensor detects both the analyte and the interferences, experiments shall be taken for specific analyte and interferences; otherwise there may be reactions between the analyte and the interferences, causing some variations of chemical properties of the analyte and inaccuracy of the detection [E. T. Zellers, S. A. Batterman, M. Han, and S. J. Patrash, Anal. Chem., 67, 1092, 1995].

2.4.2 Reversibility

Reversibility refers to the ability of a sensor to recover or return to its original baseline condition after the analyte is removed. It should be noted that the reversibility of reaction between the coating and the analyte should also be considered; the reversibility mainly depends on the intensity, kinetic energy, and heat energy of the reaction. Sometimes, the reversibility under room temperature is not quick or evident. There are mainly 3 causes: (1) if the energy required to remove the analyte is very high, the temperature has to be increased to assist reversion; but sometimes the sensor or the coating may be destroyed at the high temperature; (2) during some reactions, new substances may be created, which causes the chemical properties of the coating changed completely; (3) the reaction between the analyte and the coating is too vehement and cause the physical structure of the coating altered permanently. For example, if the carbon-carbon bonds in the polymer coating are broken, the polymer will become a strong oxidizer.

2.4.3 Sensitivity

For a reversible sensor, sensitivity refers to the ratio between the change in sensor output signal and the change in the concentration of the analyte. Sensitivity depends on a number of factors; for example, for an acoustic wave device, the sensitivity to the analyte is mainly determined by the adsorptive capacity of the coating (thickness and surface area) and the intensity of reaction between the analyte and the coating.

2.4.4 Dynamic Range

Dynamic range refers to the concentration interval over which a sensor provides a continuously changing response. Linear dynamic range (LDR) further contains this interval to that region in which linear proportionally between response and concentration is maintained. Dynamic range is bounded by the limit of detection (LOD) and the saturation effect. The occurrence of the saturated phenomenon is related to the chemical limitation of the system or the saturation of the electronic circuit. If the concentration of the analyte is lower than said LOD, it is impossible to detect the analyte, i.e., it is impossible to discriminate the signals from the noise; if the concentration of the analyte is higher than the saturation concentration, all give the same response.

Like the response mechanism of sensitivity, LOD depends on the kinetic and thermodynamics of the coating-analyte interaction. Unlike sensitivity, however, LOD also depends on the noise level of the entire system. LOD is expressed in terms of the ratio between the response when the analyte is present and the noise level when there is no analyte present. Commonly, LOD is defined as signal-to-noise (S/N) ratio of two or three.

2.4.5 Stability, Repeatability, Reliability, and Reproducibility

The stability of the system is very important and it mainly involves short-term stability, long-term stability, and noise and drift. The criterion of short-term stability is rapid response capability of the device in a short term. Noise may result in an extremely high LOD and inaccuracy of signals. Short-term drift, often associated with short-term changes in ambient parameters such as temperature, pressure, and relative humidity, can exceed oscillator noise, in which case drift dictates the LOD. Long-term stability refers that aging of the sensor (e.g., coating, elements, and electronic circuit) will cause drift of the signals and may require frequency recalibration.

Repeatability refers that the same sensor under the same operational environment and the same analyte concentration produces same signals. A high degree of repeatability requires either that the coating-analyte interaction be reversible or that response lies within the linear region of dynamic range.

Reliability is the same as repeatability, except that the responses are obtained under the variety of ambient conditions excepted for a particular sensor application.

Reproducibility and repeatability are often confused. Reproducibility refers that the same product made through the same manufacturing process at different times and different facilities has same properties.

2.4.6 Response Time

Response time depends on the properties of the sensing system, for example, cell volume and gas/liquid-delivery system, properties of coating (i.e., thickness), and sorption/reaction kinetics. The rate of adsorption and desorption determine the response time of the sensor. For reactive coatings, reaction rates can be affected reagent surface area. Small particle sizes and highly porous supports that maximize area/volume ratio yield a larger response in a shorter period of time.

2.4.7 Environment Effect

The most significant environment factor affecting sensor performance is temperature. The effect of temperature on acoustic wave devices is extensive, for example, variation of temperature may alter the oscillation frequency of acoustic wave sensor and decrease sensitivity. To minimize temperature effect, a piezoelectric substrate with small or zero temperature coefficient of delay (e.g., a quartz substrate) in the temperature region of interest may be selected. Another approach is to deposit other metal or oxide layers on a thin piezoelectric substrate to yield a composite structure exhibiting minimal temperature coefficient. In addition, temperature-drift compensation can be accomplished by using a dual-device configuration. However, such a structure may not compensate completely the deviation because that the temperature effects of the two elements may be not completely identical.

Another significant environment factor is humidity, which may alter the properties of the coating (i.e., makes the coating softened) and result in frequency shift. Therefore, careful selection of coating materials can minimize the effect of vapor on the sensor response.

### EMBODIMENTS

Hereinafter we will describe the present invention in detail with embodiments; however, it should be appreciated that the present invention is not limited to the embodiments described hereinafter.

### Embodiment 1 Manufacturing of an Ammonia Gas sensor

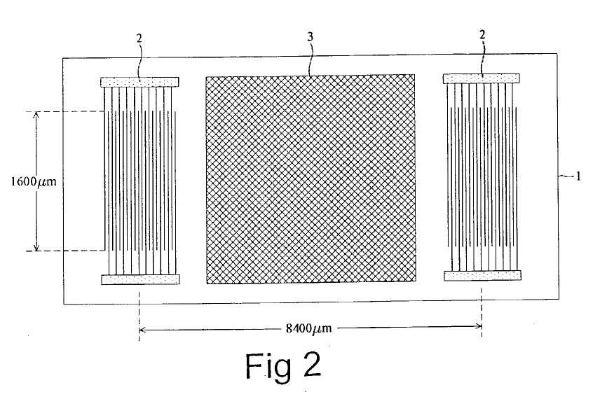

An embodiment in present invention provides an ammonia gas sensor as shown in FIG. 2, wherein said device comprises a piezoelectric substrate 1, a surface acoustic wave sensor (a delay line) 2; wherein said surface acoustic wave sensor comprises two IDTs and a L-glutamic acid hydrochloride coating 3. Said piezoelectric substrate 1 is made of quartz, Rhode salt, tourmaline, lithium niobate (LiNbO3), lithium tantalante (LiTaO3), barium titanate (BaTiO3), leadzirconate (PZT), zinc oxide, aluminum nitride, Li2B4O7 (LBO), or combinations of above materials. Said piezoelectric substrate may be a single layer one or a multilayer one. The ammonia gas sensor in present invention employs a surface acoustic wave device because the surface acoustic wave device has the following advantages and is suitable to serve as a sensor:

(1) High sensitivity. The shift of operating frequency is hundreds of Hz to hundreds of KHz, and the precision of the measuring instrument may be 1 Hz. For instance, 0.1% displacement will result in 200 KHz frequency shift on the resonator working at 200 MHz; theoretically, an instrumental measurement with precision of 1 Hz may detect 5×10⁻⁹ displacements.

(2)High S/N ratio, without the need of an expensive D/A converter.

(3)High resonant frequency (10˜3,000 MHz), resulting in wider detection range [H. Nakahata, K. Higaki, S. Fujii, and A. Hachigo, IEEE Ultrasonics. Symp. Proc., 361, 1995.].

(4)Easier to manufacture than BAW sensors, suitable for mass production with photolithography and lift-off technologies, and the production cost may be less.

The present invention employs a L-glutamic acid hydrochloride coating 3 formed on a surface acoustic wave device. Studying the infrared spectra, we learn that said L-glutamic acid hydrochloride has evident adsorptive effect as well as high selectivity to ammonia gas.

The manufacturing method of the ammonia gas sensor in present invention is: provide a substrate 1; form a surface acoustic wave delay line 2 on said substrate, said sensor comprising a first set of IDTs and a second set of IDTs, said surface acoustic wave delay line 2 is formed with lift-off technology or with photolithography technology and deposit L-glutamic acid hydrochloride solution between said first set of IDTs and said second set of IDTs on said substrate to form a L-glutamic acid hydrochloride coating 3, said forming said L-glutamic acid hydrochloride coating 3 may be done through spray coating or spin coating.

Said piezoelectric substrate is a 128° YX-LiNbO3 substrate. Said IDTs are made of aluminum, gold, or gold alloy (1,500 Å aluminum in the present embodiment). As shown in FIG. 2, the center frequency of the surface acoustic wave delay line is 100 MHz and the period of IDT was 40 μm. Each IDT had 10 finger-pairs and an acoustic aperture was 1600 μm. The center-to-center spacing between the two IDTs was 8400 μm. Dissolve the L-glutamic acid hydrochloride in 75° C. deionized water to obtain 0.5 mg/ml L-glutamic acid hydrochloride solution. Before spreading the coating, the surface of surface acoustic wave delay line 2 is cleaned through vibration with acetone and then dried in a dryer at 80° C. After that, the L-glutamic acid hydrochloride is deposited on the surface of the surface acoustic wave device through spraying.

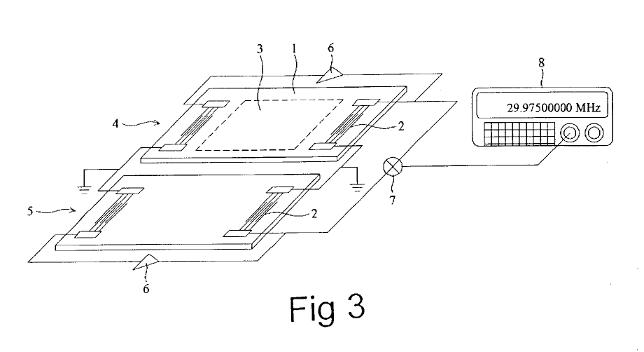

The ammonia gas sensor is present invention employs a dual delay line configuration to minimize environment effects. As shown in FIG. 3, the detecting delay line 4 and the reference delay line 5 is connected to a electronic oscillation circuit 6, respectively, with a circuit mixer 7 connecting the two devices. A frequency counter 8 is used to record oscillation signals of surface acoustic wave. Said frequency counter 8 is connected to a computer system via a GPIB. The 2 electronic oscillation circuits 6 may generate RF surface acoustic wave oscillation signals.

### Embodiment 2. Measuring the Response to Ammonia Gas with the Ammonia Gas sensor

Place the ammonia gas sensor in the present invention into a temperature-controlled closed chamber (volume: 132 ml) and control the flow rate of the gas with a mass flow controller, which is set at 110 ml/min. Both the reference gas and the carrier gas are dry air, which is used to dilute ammonia gas. The response of the ammonia gas sensor to different concentrations of ammonia gas is observed. In addition, the humidity effect is also observed, wherein the humidity varies between 0˜90%. Different relative humidity values are obtained through mixing dry air and humid air at different proportions. A frequency counter is used to record the frequency shift. Noise measurement were determined from frequency data collected for 10 min at 20 points per min, and the noise was taken as the standard deviation of the residuals of the linear least squares fit through the data. [C. Y. Shen, C. P. Huang, and H. C. Chuo, Sen. Actuators B, 84, 231, 2002].

### Embodiment 2.1 Response of the Ammonia Gas sensor under Room Temperature

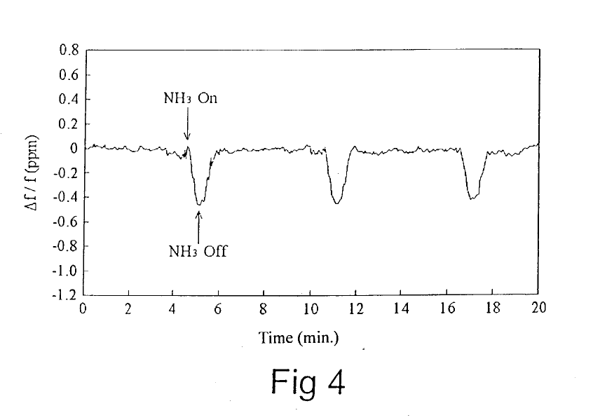

FIG. 4 shows the real-time responses of the SAW sensor in dry air at room temperature. The response time is in seconds of exposure to ammonia in dry air and the response quickly returns to the base line when ammonia turns off. Three gas on/off cycles produce similar responses, revealing repeatable and sensitive detection properties. The time responses are almost the same. It means that the L-glutamic acid hydrochloride film is reversible. The noise in the response diagram always is 0.02 ppm.

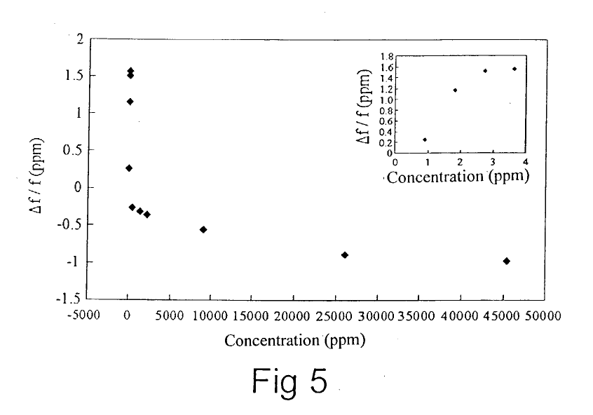

FIG. 5 shows the ammonia concentration dependence of the frequency shift of the sensor in dry air at room temperature in present invention.

For a low ammonia gas concentration, the response frequency of the ammonia gas sensor increases; for a high ammonia gas concentration, the response frequency of the ammonia gas sensor decreases. When the coating absorbs high concentration ammonia gas, mass loading effect is more significant than elastic effect, which cause the frequency to decrease; due to the fact that L-glutamic acid hydrochloride is a stiff material, at a lower ammonia gas concentration, elastic effect is more significant than mass loading effect, which cause the frequency to increase. Acoustoelectric effect is not taken into consideration in the embodiment due to the fact than L-glutamic acid hydrochloride is a non-conducting material. From the figure we can see that the dynamic range of L-glutamic acid hydrochloride is very wide. The detectable level of 0.90 ppm ammonia is a limit of the system presented herein and is not a detection limit of L-glutamic acid hydrochloride. The slope of the response curve for ammonia gas above 2,300 ppm is evidently smaller than that for ammonia below 2,300 ppm, and that is mainly because the response tends to saturate at a higher ammonia gas concentration. The slope in the figure is defined as sensitivity, which is about 5.04 kHz/ppm for ammonia gas below 2,300 ppm. From above result we can see that the L-glutamic acid hydrochloride coated surface acoustic wave sensor is highly sensitive to ammonia gas.

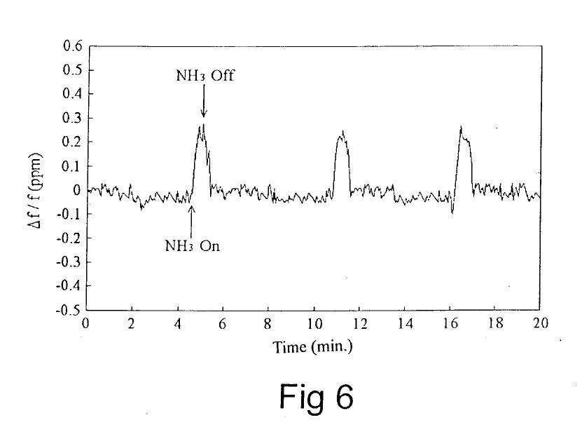

FIG. 6 shows the case where the concentration of ammonia gas is extremely low. From FIG. 6 we can see that the ammonia gas sensor in present invention can detect ammonia gas easily even when the concentration of ammonia gas is lower than 1 ppm. The gas detection limit is defined as being that the signal measured is no smaller than two times the noise level, i.e., the S/N ratio is 2 or above. The S/N ratio of the ammonia gas sensor in present invention to 0.90 ppm ammonia gas is 12.29, which is much higher than 2. Therefore we can see that the minimal concentration detectable with the ammonia gas sensor in present invention is surely less than 0.9 ppm.

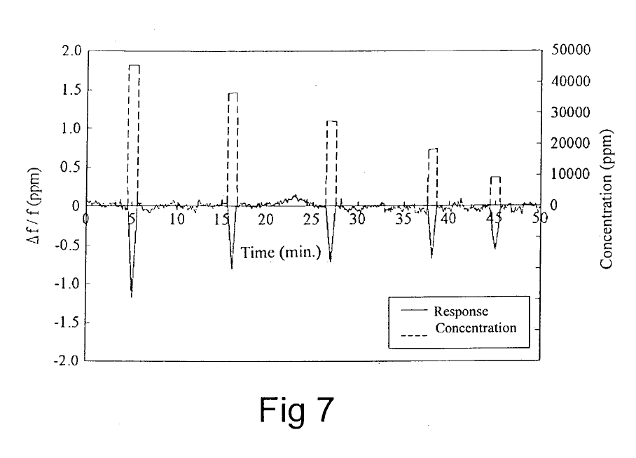

FIG. 7 shows the instantaneous response of the ammonia gas sensor in present invention to ammonia gas. Due to the fact that the response of ammonia gas sensor to ammonia gas decreases with the decrease of ammonia gas concentration, the ammonia gas sensor may be used to monitor variation of ammonia gas concentration in real time.

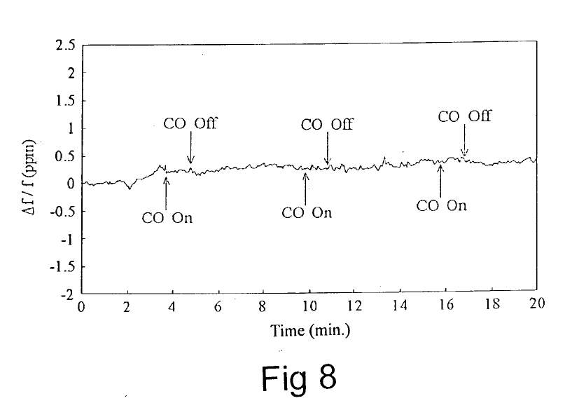

FIG. 8 shows the frequency response of the ammonia gas sensor in present invention to carbon monoxide (CO). No effect is observed from this interference gas. The other interference gases show the same result.

Therefore, L-glutamic acid hydrochloride has a good selectivity to ammonia.

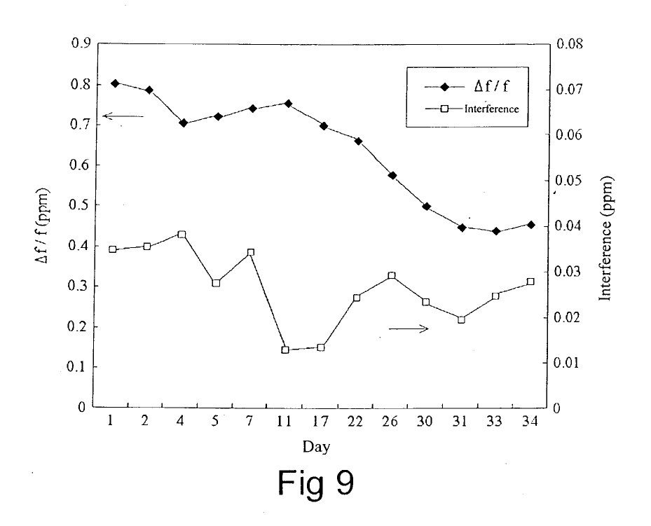

FIG. 9 shows the result of long-term stability test to the ammonia gas sensor in present invention (34 days, with 3.04% ammonia gas). From the figure we can see that there is some deviation in the response, which may be attributable to aging of L-glutamic acid hydrochloride (response degradation rate: 0.01 ppm/day). However, that is a trivial degradation rate. We can say that the ammonia gas sensor in present invention exhibits high stability.

### Embodiment 2.2 Influence of Humidity to Frequency Response of Ammonia Gas sensor

The frequency response of the surface acoustic wave device measured under different relative humidity values. The result shows that the response of the device increases slightly with the increase of humidity.

Therefore the ammonia gas sensor in present invention has some response to water molecules. The influence of relative humidity to the sensitivity of the device to ammonia gas should be taken into account.

Formula (2) shows the reaction of the ammonia gas sensor to humidity:

S_{(NH}_{₃}_{,H}_{₂}_{O)}=S_{(NH}_{₃}₎+S_{(H}_{₂}_{O)}+D.S_{(NH}_{₃}₎.S_{(H}_{₂}_{O)} (2)

Wherein S_{(NH}_{₃}_{,H}_{₂}_{O)} is the frequency shift to ammonia in humid air, S_{(NH}_{₃}₎ is the frequency shift of the sensor to ammonia in dry air, S_{(H}_{₂}_{O)} is the response of the sensor to water molecules, and “D” is cross-sensitivity. The third item on the right of the equal mark represents the mutual dependence of the response on ammonia and moisture, i.e., the impact to the response of the entire system in an environment where ammonia gas and moisture coexist. In addition, “D” decreases with the increase of relative humidity. From the result of the ammonia gas sensor in present invention we can see that “D” is 0.011 in a 35˜50% humidity environment. Such a value is much lower than the values for “D” in traditional sensors. Therefore the ammonia gas sensor in present invention is inactive to humidity.

### Conclusion

The ammonia gas sensor in present invention employs a L-glutamic acid hydrochloride coating. From the result we can see that the device has high reliability, sensitivity, reversibility, repeatability, and selectivity to ammonia gas. At room temperature, the minimal detecting limit of the L-glutamic acid hydrochloride to ammonia gas is less than 0.90 ppm, which is much lower than that of traditional surface acoustic wave sensors (10-20 ppm). Furthermore, traditional surface acoustic wave sensors usually work at a temperature higher than room temperature or the response degradation rate of them is very high at room temperature. However, the ammonia gas sensor in present invention has high stability to ammonia gas at room temperature, which is a great breakthrough. In addition, the L-glutamic acid hydrochloride has excellent real-time response to ammonia gas in the air but no response to other disturbing gases. Humidity also has influence on the adsorption characteristics of the sensor to ammonia gas. Therefore the device preferably works in a dry environment. However, the influence of humidity to present invention is much lower than that to traditional sonic sensors.

Though the invention is described as above with preferred embodiments, the invention is not limited to those embodiments. Anyone familiar to the art may easily make modifications or embellishments on the basis of the present invention. However, any applications implemented with equivalent modifications or embellishments to present invention shall fall in the scope of present invention, which is only confined by the claims attached.

1. An ammonia gas sensor, comprises:
a piezoelectric substrate;
a surface acoustic wave device, and;
a L-glutamic acid hydrochloride coating, wherein said surface acoustic wave device and said L-glutamic acid hydrochloride coating are formed on said piezoelectric substrate.

2. The ammonia gas sensor described as in claim 1, wherein said piezoelectric substrate is a single-layer piezoelectric substrate.

3. The ammonia gas sensor described as in claim 1, wherein said piezoelectric substrate is a multilayer piezoelectric substrate.

4. The ammonia gas sensor described as in claim 2 or 3, wherein said piezoelectric substrate is made of quartz, lithium niobate (LiNbO3), lithium tantalante (LiTaO3), Li2B4O7 (LBO), barium titanate (BaTiO3), leadzirconate (PZT), zinc oxide, aluminum nitride, or combinations of those materials.

5. The ammonia gas sensor described as in claim 1, wherein Said surface acoustic wave device comprises a delay line, a one-port resonator, a two-port resonator, or a reflective delay line.

6. The ammonia gas sensor described as in claim 5, wherein said delay line is a dual delay line.

7. The ammonia gas sensor described as in claim 6, wherein said device comprises two IDTs.

8. The ammonia gas sensor described as in claim 5, wherein said IDTs are made of aluminum, gold, or another gold alloy.

9. The ammonia gas sensor described as in claim 7 further comprises an electronic oscillation circuit connected to said IDTs.

10. The ammonia gas sensor described as in claim 1, wherein said L-glutamic acid hydrochloride coating is formed on said piezoelectric substrate with L-glutamic acid hydrochloride solution.

11. The ammonia gas sensor described as in claim 10, wherein the deposition of said L-glutamic acid hydrochloride solution is done through spray coating or spin coating.

12. The ammonia gas sensor described in claim 9 further comprises a frequency counter connected to said electronic oscillation circuit to receive a signal generated by said electronic oscillation circuit.

13. A method for manufacturing ammonia gas sensors comprises the following procedures:
provide a substrate;
form a surface acoustic wave device on said substrate, and;
deposit a L-glutamic acid hydrochloride coating on said substrate.

14. The method of manufacturing ammonia gas sensors as described in claim 13, where said substrate is a single-layer substrate.

15. The method of manufacturing ammonia gas sensors as described in claim 13, where said substrate is a multilayer substrate.

16. The method of manufacturing ammonia gas sensors as described in claim 14 or 15, where said substrate is made of quartz, lithium niobate (LiNbO3), lithium tantalante (LiTaO3), Li2B4O7 (LBO), barium titanate (BaTiO3), leadzirconate (PZT), zinc oxide, aluminum nitride, or combinations of above materials.

17. The method of manufacturing ammonia gas sensors as described in claim 13, wherein the formation of said surface acoustic wave sensor is done with photolithography technology or lift-off technology.

18. The method of manufacturing ammonia gas sensors as described in claim 13, wherein said surface acoustic wave device comprises a delay line, a one-port resonator, a two-port resonator, or a reflective delay line.

19. The method of manufacturing ammonia gas sensors as described in claim 18, wherein said delay line is a dual delay line.

20. The method of manufacturing ammonia gas sensors as described in claim 19, wherein said system comprises two IDTs.

21. The method of manufacturing ammonia gas sensors as described in claim 20, wherein said IDTs are made of aluminum, gold, or another gold alloy.

22. The method of manufacturing ammonia gas sensors as described in claim 13, wherein The deposition of said L-glutamic acid hydrochloride coating is done with a L-glutamic acid hydrochloride solution through spray coating or spin coating.
